(19) United States
(12) Patent Application Publication
(10) Pub. No.: US 2012/0031891 A1
(43) Pub. Date: Feb. 9, 2012

(54) Furnace

(75) Inventor: Stephan Miller, Traunstein (DE)

(73) Assignee: DEKEMA Dental-Keramikoefen GmbH, Freilassing (DE)

(21) Appl. No.: 12/881,447

(22) Filed: Sep. 14, 2010

(30) Foreign Application Priority Data
Aug. 5, 2010 (DE) 20 2010 011 110.2

(51) Int. Cl. A61C 13/20

(52) U.S. Cl. 219/392

(57) ABSTRACT

The invention relates to a furnace for the firing of dental prostheses or partial dental prostheses having a firing chamber, a heating device for the heating of the firing chamber, a firing tray arranged within the firing chamber during firing and a lifting mechanism for raising and lowering the firing tray. A moving mechanism is additionally provided by which the firing tray can be moved with an open firing chamber between a lifting position and a loading position laterally offset thereto.

The present invention relates to a furnace for the firing of dental prostheses or partial dental prostheses.

Such furnaces as a rule have a firing chamber, a heating device for the heating of the firing chamber and a firing tray arranged within the firing chamber during firing. In conventional furnaces, a lifting mechanism can be provided, for example, which serves for raising and lowering the firing tray to move it between a loading position and a firing position.

An important property of furnaces of the initially named kind is a simple and safe operability in order, on the one hand, to allow an economically efficient operation of the device and, on the other hand, to ensure the safety of the operator. In addition, it is of great importance that a homogeneous temperature distribution is present at least in a region in which the dental prosthesis or partial dental prosthesis to be fired is located in the firing process.

It is therefore an object of the present invention to provide a furnace which is easy and safe to operate and which simultaneously provides reliably good firing results.

This object is satisfied by a furnace having the features of claim 1.

The furnace in accordance with the invention of the initially named kind additionally has, beside the lifting mechanism, a moving mechanism by which the firing tray is movable with an open firing chamber between a lifting position and a loading position laterally offset thereto.

In other words, the mechanism provided for the loading of the furnace includes components which allow a lateral movement of the firing tray in a horizontal plane and a vertical movement perpendicular thereto. A loading of the firing tray is simplified by the lateral movement since said firing tray—unlike loading mechanisms which only comprise a lifting mechanism—is also easily accessible from above, for example. After the loading of the firing tray in the loading position, it is moved into a lifting position. The firing chamber is open during this process. Subsequently, a vertical movement—raising or lowering—of the firing tray is initiated to move the firing tray into the firing chamber until the firing material is located in a predefined position in the interior of the firing chamber. The firing chamber is preferably closed by the vertical movement.

It is efficiently prevented by the vertical and lateral offset between the loading position/unloading position of the firing tray and the firing chamber that the operator comes too close to the firing chamber, which may in particular still be very hot after a firing process under certain circumstances. The embodiment of the furnace in accordance with the invention described above can moreover be implemented in a very compact configuration from a construction aspect.

In accordance with an embodiment of the furnace, the firing tray is arranged on a platform, with the platform in particular having at least one thermally insulating component which at least functionally forms a section of the firing chamber or a closure of a loading opening of the firing chamber. For example, the platform is a base or a top of the firing chamber and essentially has the same insulation as the rest of the firing chamber. Provision can, however, also be made that the firing chamber is provided with a loading opening which does not include the whole base region of the firing chamber and which can be closed by a platform acting as a kind of stopper. It is generally also possible that the platform includes a section of the firing chamber, for example, a lower half of the firing chamber, so that the platform not only includes a base of the firing chamber, but also a part of the side walls of the firing chamber. The firing chamber is thereby divided into two, with one part of the firing chamber being able to be raised or lowered with respect to the other part to open the firing chamber. The construction height of the furnace can thereby be reduced. The thermally insulating component can in another respect be made up of a plurality of individual parts to be able to provide the desired insulating properties.

The firing tray can be a table-like structure, for example, which includes a table top and a frame, in particular of ring shape, on which the table top is arranged. The ring-shaped frame can have cut-outs in order also to allow a radiation connection at the lower side of the table top of the firing tray, whereby an improved temperature distribution is achieved in the region of the firing material to be fired.

The platform is in particular releasably connectable to the lifting unit and/or to the moving mechanism. It lies, for example, only on the named components. It is thus possible also to load the platform separately from the furnace or to wait and only to bring it into connection with the lifting unit and/or the moving mechanism when the furnace is in use. The lifting unit and the moving mechanism are in particular designed such that the platform is transferred from the moving mechanism to the lifting unit, or vice versa, during the feeding process.

The thermally insulating component of the platform can have sealing segments which are associated with sealing segments of an insulation of the firing chamber which are complementary thereto. They can, for example, be provided by a suitable embodiment of the section of the insulating component and of the corresponding regions of the insulation of the firing chamber which are in contact with the insulating component with a closed firing chamber. The insulating components can, for example, have a step which cooperates in an exactly fitting manner with a step of complementary design at the insulation of the firing chamber to close it and to prevent the arising of cold bridges as much as possible.

A safety device can be provided for the avoidance of incorrect operations of the furnace, said safety device being configured such that the lifting unit can only be activated when the moving mechanism is in a predefined position. Alternatively or additionally, the safety device can be configured such that the moving mechanism can only be activated when the lifting unit is in a predefined position. The safety device can, for example, have mechanical guide elements which serve for the aforesaid purpose. IT is also additionally or alternatively possible to provide sensors which detect the position of the lifting unit or of the moving mechanism and forward it to a control unit to be able to control the moving mechanism or the lifting unit accordingly.

A locking device can furthermore be provided which is configured such that the moving mechanism can be locked in at least one predetermined position and/or such that the lifting unit can be locked in at least one predetermined position. The locking device can have a pivotable blocking element which is pivotable into or out of a blocking position by a vertical movement of the firing tray and/or of the platform to secure or release the moving mechanism.

The lifting unit preferably includes a scissor lifting mechanism which can in particular be driven by a spindle drive. Such a mechanism or drive is compact and reliable.

The furnace in particular has a housing which surrounds the firing chamber, the firing tray and—at least in the closed state of the furnace—the lifting unit and the moving mechanism, with the housing preferably having a housing section separated at least partly from the remainder of the housing by a partition wall. The housing section is arranged laterally offset to the firing chamber so as to be influenced less pronouncedly by heat escaping from the firing chamber on an opening thereof. The housing section also accepts means for the actuation and/or control of the lifting unit and/or of the moving mechanism.

A handle can be provided for the actuation of the moving mechanism which is coupled with the platform and which is movable, in particular pivotable, in dependence on the lifting position between an engagement position and a rest position. The position of the handle thus indicates the position in which the platform is located. The handle preferably has an operational surface which is biased against an actuation section of the platform and which is configured such that the handle is automatically pivotable at least partly into an interior of a housing of the furnace by a movement of the platform in the direction of the firing chamber. The operator is in particular reliably prevented from opening the furnace when the handle is pivoted so far into the housing from a predefined lifting position of the platform onward that its actuation is no longer easily possible.

The operational surface can have a latch section which is in contact with the actuation section of the platform in a lower end lifting position of the firing tray to secure the position of the handle with respect to the housing of the furnace.

The invention further relates to a furnace for the firing of dental prostheses or partial dental prostheses having a firing chamber, a heating device for the heating of the firing chamber and a firing tray arranged within the firing chamber during firing, in particular in accordance with at least one of the embodiments described above.

In accordance with the invention, the heating device includes one or more heating elements, with all the heating elements of the heating device—that is the one heating element or all of the plurality of heating elements—being arranged, in the position of use of the furnace, above a plane which is called the firing material plane and in which firing material to be fired is arranged in a loaded state of the furnace.

This means that all the heating elements are located above the dental prostheses or partial dental prostheses to be fired with a closed heating chamber—relative to a position of use of the furnace. A comparatively large region can thereby be provided in an efficient manner in which the temperature distribution is homogenous and corresponds to the respectively applicable process instructions. In addition, the firing chamber can be given a compact design in such an arrangement of the heating elements, in particular when all the heating elements are arranged in an upper third of the firing chamber, preferably in each case in direct proximity to an inner side wall and/or a top of the firing chamber. A further advantage is that a feeding of the firing chamber can easily be realized from below in this type of construction.

The heating device can include at least two heating elements which are arranged in a substantially horizontal plane to achieve a homogeneous temperature distribution.

The heating elements can be made elongate, in ring-shape or helical to be able to produce a desired temperature distribution in the firing chamber. Combinations of differently designed heating elements are also conceivable to provide a heating device suitable for the respective firing chamber.

The heating element or—if a plurality of heating elements are provided—the heating elements can be arranged at least partly laterally offset to the firing tray with respect to a vertical projection of the firing tray to prevent material falling from the heating element(s) from falling directly onto the firing material and contaminating it.

To utilize the heat output of the heating elements as efficiently as possible and simultaneously to keep the firing chamber small and therefore able to be heated homogeneously more easily, an inner side wall of the firing chamber which extends parallel to the at least one, preferably elongate, heating element can have a slanted extent at least sectionwise with respect to a vertical.

Further features of the invention are set forth in the description, in the claims and in the drawings.

An embodiment of the present invention will be described in the following purely by way of example with reference to the enclosed drawings. There are shown:

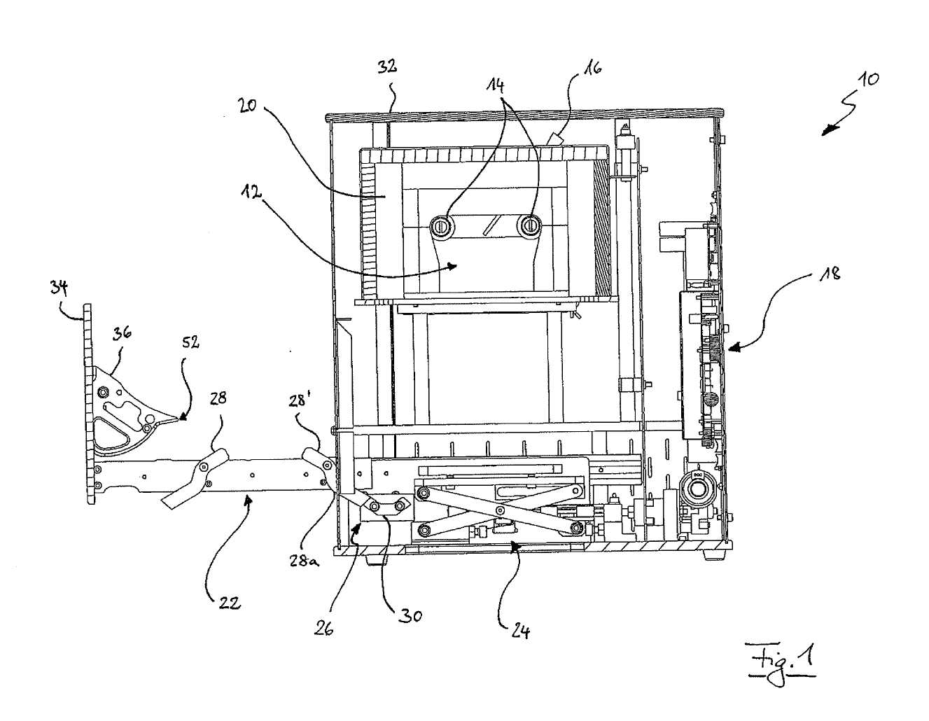

FIGS. 1 to 5 sectional drawings through an embodiment of the furnace in accordance with the invention in respective different respective states.

FIG. 1 shows a furnace 10 with a firing chamber 12 which can be heated with the help of two elongate heating elements 14 arranged parallel and perpendicular to the plane of the drawing. A sensor 16 is provided to monitor the temperature in the firing chamber 12 and is connected to control electronics 18 which in turn control the heating elements 14 in dependence on the signals of the sensor 16 and on a DESIRED temperature value preset by a firing program.

The firing chamber 12 is surrounded by an insulation layer 20. The insulation layer 20 is—as can be seen in FIG. 1—composed of a plurality of different components to screen the environment from the high temperatures in the interior of the firing chamber which occur in a firing process of dental ceramics.

In the condition shown, the firing chamber 12 is open at the bottom to enable a feeding of the fuel chamber 12 from this side. The feeding of the firing chamber 12 takes place by a moving mechanism 22 and a lifting mechanism 24. The moving mechanism 22 is made in the manner of a drawer. In the condition shown, a base section of the firing chamber 12 serving as a closure and having a firing tray arranged thereon is not yet arranged on the moving mechanism 22. A locking device 26 is provided to secure the moving mechanism 22 in the position shown and to enable a loading thereof. The locking device 26 includes a left-hand and a right-hand two-armed pivot lever 28 and 28′ respectively which were pivoted into the position shown due to gravity alone in the situation shown. A right hand arm 28a of the pivot lever 28′ cooperates with an abutment 30 to prevent the moving mechanism 22 from being able to be moved into a housing 32 of the furnace 10.

A housing door 34 at which a grip 36 is pivotably supported is arranged at the moving mechanism 22. The grip 36 is automatically pivoted inwardly by the effect of a biasing device (not shown).

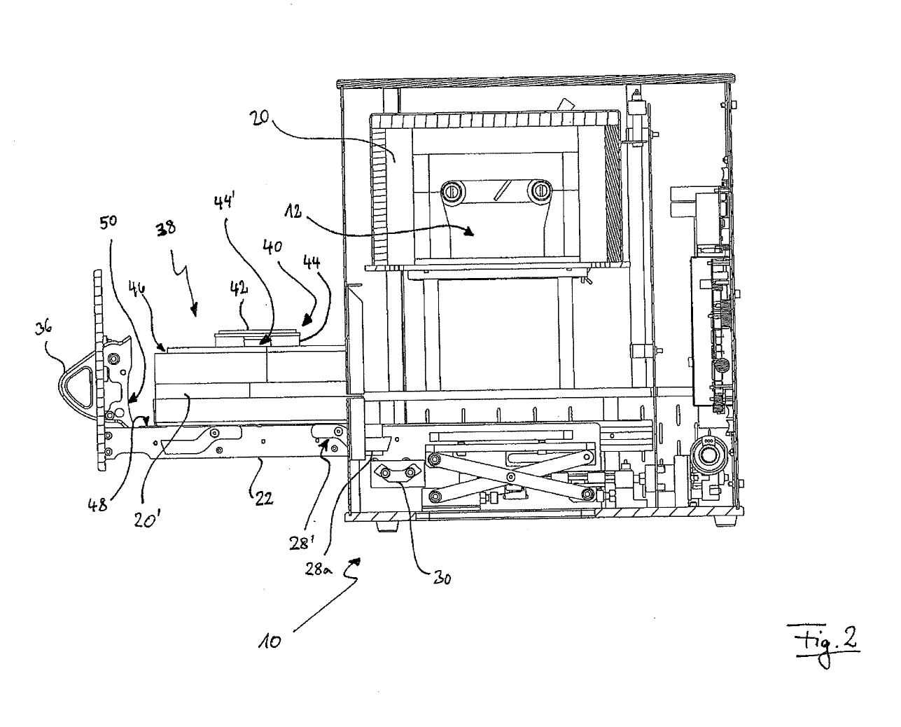

FIG. 2 shows the furnace 10 still in an open state. However, unlike the situation in FIG. 1, a base section 38 is now arranged on the moving mechanism 22 and serves for the closing of the firing chamber 12 at the base side. The base section 38 is made in table top form and includes a recess in which a firing tray 40 is arranged on which a firing material (not shown) to be fired can be arranged. The firing tray 40 includes a table top 42 and a crown-shaped frame 44 which is essentially formed by a ring which has U-shaped cut-outs 44′ at its upper side. The cut-outs 44′ make it possible that heat radiation can also impact the table top 42 obliquely from below, whereby a more uniform heating of the firing material arranged thereon is produced in the firing process.

The base section 38 has an insulation layer 20′ which is made in a comparable manner to the insulation layer 20 of the upper part of the firing chamber 12. The insulation layer 20′ has a step 46 which ensures, together with a step of the insulation layer 20 (not shown) made in a complementary manner, a good thermal insulation of the firing chamber 12 in the closed state.

The right-hand pivot lever 28′ was pivoted by the placing of the base section 38 onto the moving mechanism 22 so that the pivot lever arm 28a is no longer in contact with the abutment 30 and the moving mechanism 22 can thus be pushed into the housing 32 of the furnace 10 in a similar manner to a drawer.

The grip 36 was moreover outwardly pivoted when the base section 38 was placed on to indicate that the moving mechanism 22 is now loaded and to give an operator the opportunity also to be able to operate it comfortably. The pivoting of the grip 36 is produced by a cooperation of an actuation section 48m which is made from Teflon, for example, and which is arranged at the base section 38 with an operational surface 50 formed at the grip 36. As can be seen in FIG. 1, a lower section of the operational surface 50 has a latch section 52 which ensures that the base section 38 is not tilted on a pushing movement of the moving mechanism 22 by means of the grip 36, which would be the case if the actuation section 48 were in contact with the operational surface 50. The latch section 52 is, for example, a surface which is vertical—with respect to the position of the handle 36 shown in FIG. 2—or a surface which extends slightly obliquely to the vertical from the bottom left to the top right.

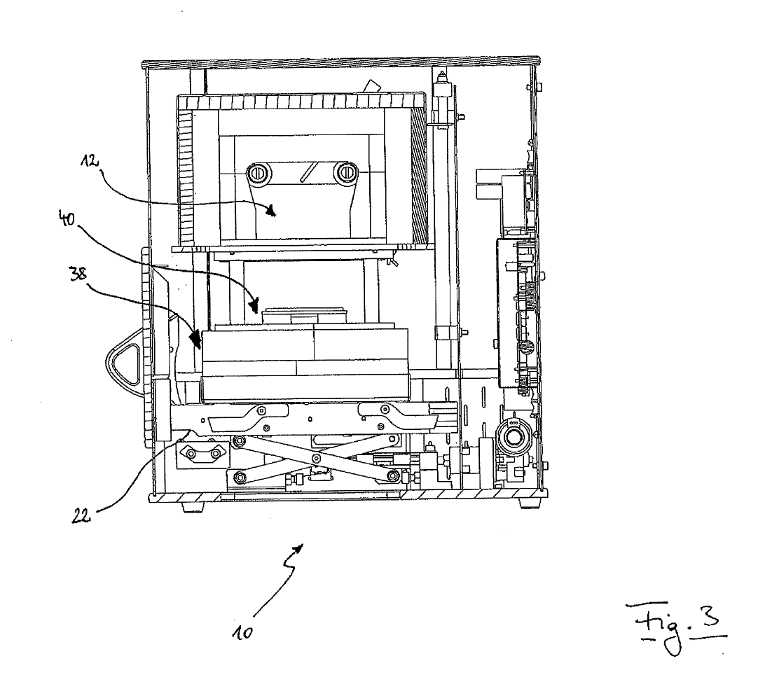

FIG. 3 shows the furnace 10 in a condition in which the moving mechanism 22 has reached an end abutment with respect to a horizontal movement. The base section 38 is now located beneath the firing chamber 12 and has to be raised to close it at the base side and to bring the firing tray 40 into the suitable position for the firing of the firing material. A securing device can be provided which ensures that a lifting movement of the base section 38 can only be initiated when the end abutment is reached.

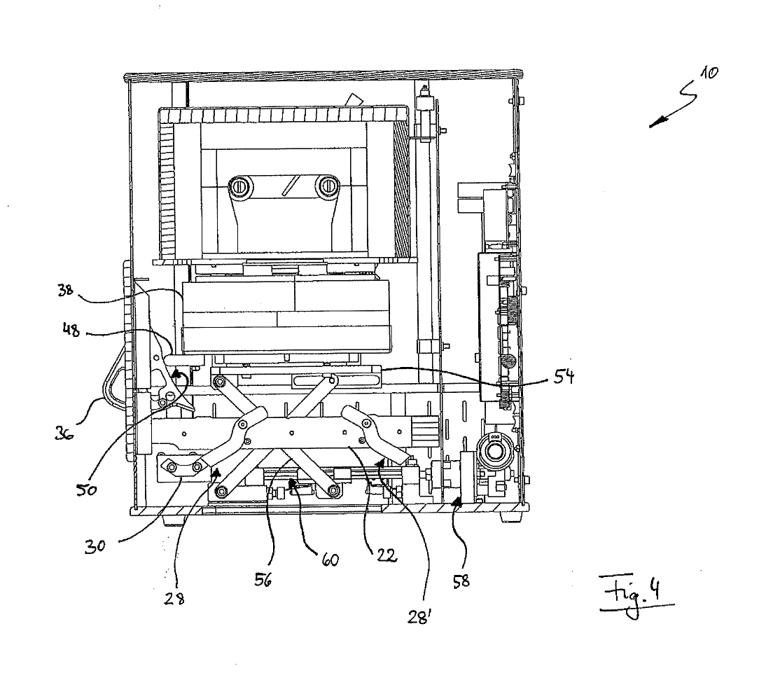

FIG. 4 shows the furnace 10 in a snapshot during the lifting movement of the base section 38. The base section 38 which previously lies on the moving mechanism 22 now lies on a lifting plate 54 which is raised by a scissor lifting mechanism 56 of the lifting mechanism 24 which is in turn actuated by a spindle drive 60 driven by a motor 58. It was made possible by the raising of the base section 38 for the pivot levers 28, 28′ to pivot, with the left hand pivot lever 28 now preventing, in cooperation with the abutment 30, an inadvertent actuation of the moving mechanism 22.

It can furthermore be recognized that the grip 36 folds into the housing interior due to the bias acting on the grip 36 and to the cooperation of the actuation section 48 with the operational surface 50 to indicate that the base section 38 is in a lifting movement. The moving mechanism 22 is admittedly—as described—secured by the left hand pivot lever 28 and the abutment 30 against an inadvertent actuation; however, the safety of the furnace 10 is additionally improved by this visual indication of the position of the base section 38.

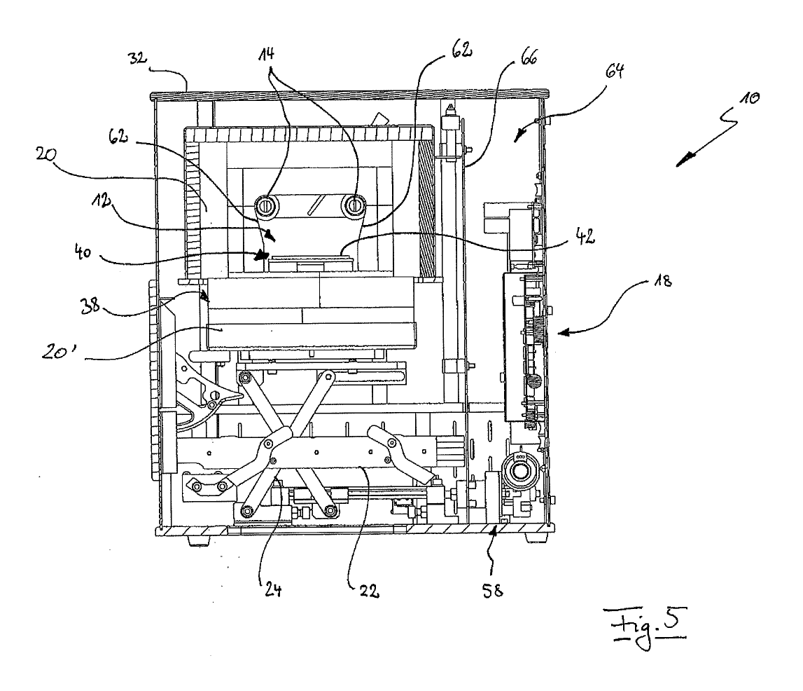

FIG. 5 shows the furnace 10 with a closed firing chamber 12. The base section 38 now closes the firing chamber 12 and the firing tray 40 is located in a position in which the firing material (not shown) lying on the table top 42 is located in a region which has a homogeneous temperature distribution in the firing process.

The heating elements 14 are arranged outwardly offset somewhat with respect to a vertical projection of the table top 12 to prevent material which may release from the heating elements 14 under certain circumstances from falling onto the firing material. Due to the lateral offset of the heating elements 14, which are essentially arranged in a plane directly beneath the top of the firing chamber 12, the firing chamber 12 is wider in the region of the heating elements 14 than in the region of the table top 42. The side walls of the firing chamber 12 associated with the heating elements 14 therefore have side wall sections 62 inclined with respect to a vertical.

A compact construction of the furnace 10 can be realized by the feeding of the firing chamber 12 from below. In the embodiment shown, the base section 38 is a closure of the firing chamber 12 over its total base region. An advantage of this construction is that the furnace 10 can be given a comparatively compact design in the vertical direction. The minimal stroke of the base section 38, which has to be covered on the opening of the firing chamber 12 so that the firing material can be safely removed therefrom, is namely only defined by the spacing between the upper edge of the firing material on the firing tray 40 and the lower edge of the insulation layer 20. It is, however, understood that the firing chamber 12 can also have an opening at the base side which does not include the total base region of the firing chamber 12 so that parts of the base of the firing chamber 12 are connected together with a corresponding insulation at least partly fixedly to the side walls of the firing chamber 12. It is alternatively also possible to provide a partition of the firing chamber 12 in which an upper part remains fixedly in the housing, while a lower part, which includes sections of the side walls and the total base of the firing chamber 12, is moved on the opening of the firing chamber 12. This construction is characterized by a particularly small minimal stroke, in particular when the sections of the side walls associated with the lower part project beyond the upper edge of the firing material in the vertical direction.

It can furthermore be seen from FIG. 5 that the grip 36 was now completely pivoted into the housing 32 to indicate clearly, also visually, the present operating state.

An opening of the firing chamber 12 after a firing of the firing material has taken place substantially includes an actuation of the described component in reverse order. The motor 58 provides, via the spindle drive 60, that the scissor lifting mechanism 56 moves the lifting plate 54, and thus the base section 38, downwardly until it is again seated on the moving mechanism 22. The grip 36 is in this respect gradually pivoted outwardly. As soon as the base section 38 is again seated on the moving mechanism 22, the left hand pivot lever 28 again releases it so that the drawer-like moving mechanism 22 can be pulled out of the housing 32 with the help of the grip 36.

The electronics 18 required for the operation of the furnace 10 are arranged in a housing section 64 which is separated by a partition wall 66 from a part of the housing receiving the firing chamber 12, the moving mechanism 22 and the lifting mechanism 24. The motor 58 is also arranged in the housing section 64. The housing section 64 is arranged laterally offset with respect to the firing chamber 12 so that it is not impinged directly by a heat current which escapes from the firing chamber 12 on an opening thereof after a firing process. The partition wall 66 provides a sufficient thermal decoupling even if it does not thermally separate the housing section 64 from the remainder of the housing 32. The volume of the housing 32 is sufficiently large to receive the heat escaping on the opening of the firing chamber 12 so that the furnace 10 overall does not heat up excessively.

### REFERENCE NUMERAL LIST

10 furnace
12 firing chamber
14 heating element
16 sensor
18 control electronics
20, 20′ insulation layer
22 moving mechanism
24 lifting mechanism
26 locking device
28, 28′ pivot lever
28a pivot lever arm
30 abutment
32 housing
34 housing door
36 grip
38 base section
40 firing tray
42 table top
44 frame
44 cut-out
46 step
48 actuation section
50 operational surface
52 latch section
54 lifting plate
56 scissor lifting mechanism
58 motor
60 spindle drive
62 side wall section
64 housing section
66 partition wall

1. A furnace for the firing of dental prostheses or partial dental prostheses having a firing chamber (12), a heating device (14) for the heating of the firing chamber (12), a firing tray (40) arranged inside the firing chamber (12) during firing and a lifting mechanism (24) for raising and lowering the firing tray (40),
characterized in that
a moving mechanism (22) is additionally provided by which the firing tray (40) can be moved with an open firing chamber (12) between a lifting position and a loading position offset laterally thereto.

2. A furnace in accordance with claim 1, characterized in that the firing tray (40) is arranged on a platform (38), with the platform (38) in particular having at least one thermally insulating component (20′) which at least functionally forms a section of the firing chamber (12) or a closure of a loading opening of the firing chamber (12( ).

3. A furnace in accordance with claim 2, characterized in that the platform (38) is releasably connectable to the lifting unit (24) and/or to the moving mechanism (22).

4. A furnace in accordance with claim 2, characterized in that the thermally insulating component (20) of the platform (38) has sealing segments (46) with which sealing segments of an insulation (20) of the firing chamber (12) made complementary thereto are associated.

5. A furnace in accordance with claim 1, characterized in that a securing device is provided which is configured such that the lifting unit (24) can only be activated when the moving mechanism (22) is located in a predefined position; and/or in that the moving mechanism (22) can only be activated when the lifting unit (24) is located in a predefined position.

6. A furnace in accordance with claim 1, characterized in that a locking device (26) is provided which is configured such that the moving mechanism (22) can be locked in at least one predefined position; and/or in that the lifting unit (24) can be locked in at least one predetermined position.

7. A furnace in accordance with claim 6, characterized in that the locking device (26) has a pivotable blocking element (28, 28′) which is pivotable into or out of a blocking position by a vertical movement of the firing tray (40) and/or of the platform (38) to secure or release the moving mechanism (22).

8. A furnace in accordance with claim 1, characterized in that the lifting unit (24) includes a scissor lifting mechanism (56) which can in particular be driven by a spindle drive (60).

9. A furnace in accordance with claim 1, characterized in that the furnace has a housing which surrounds the firing chamber (12), the firing tray (40) and—at least in the closed state of the furnace—the lifting unit (24) and the moving mechanism (22), with the housing (32) preferably having a housing section (64) which is at least partly separated from the remainder of the housing by a partition wall (66), which is arranged offset laterally to the firing chamber (12) and which receives means (18, 58) for the actuation and/or control of the lifting unit (24) and/or of the moving mechanism (22).

10. A furnace in accordance with claim 2, characterized in that a handle (36) is provided for the actuation of the moving mechanism (22) which is coupled to the platform (38) and which is movable, in particular pivotable, between an engagement position and a rest position in dependence on the lifting position of the platform (38).

11. A furnace in accordance with claim 10, characterized in that the handle (36) has an operational surface (50) which is biased against an actuation section (48) of the platform (38) and which is configured such that the handle (36) is automatically pivotable at least partly into the interior of a housing (32) of the furnace by a movement of the platform (38) in the direction of the firing chamber (12).

12. A furnace in accordance with claim 11, characterized in that the operational surface (50) has a latch section (52) which is in contact with the actuation section (48) of the platform 838) at a lower lifting end position of the firing tray (40) to secure a position of the handle (36) with respect to the housing (32) of the furnace.

13. A furnace for the firing of dental prostheses or partial dental prostheses having a firing chamber (12), a heating device (14) for the heating of the firing chamber (12) and a firing tray (40) arranged within the firing chamber (12) during the firing,
characterized in that
the heating device includes one or more heating elements (14), with all the heating elements (14) of the heating device being arranged in the position of use of the furnace above a plane in which firing material to be fired is arranged in a loaded state of the furnace.

14. A furnace in accordance with claim 13, characterized in that all the heating elements (14) are arranged in an upper third of the firing chamber (12), with all the heating elements (14) in particular being respectively arranged in direct proximity to an inner side wall and/or to a top of the firing chamber (12).

15. A furnace in accordance with claim 13, characterized in that the heating device includes at least two heating elements (14) which are arranged in an essentially horizontal plane.

16. A furnace in accordance with claim 13, characterized in that the heating element (14) or the heating elements (14) is or are made elongate, in ring shape and/or helical.

17. A furnace in accordance with claim 13, characterized in that the heating element (14) or the heating elements (14) is or are arranged at least partly laterally offset to the firing tray (40) with respect to a vertical projection of the firing tray (40).

18. A furnace in accordance with claim 13, characterized in that an inner side wall of the firing chamber (12) extending parallel to a heating element (14) has a slanted extent (62) sectionwise with respect to a vertical.
